(19) United States
(12) Patent Application Publication
(10) Pub. No.: US 2007/0025461 A1
(43) Pub. Date: Feb. 1, 2007

(54) Phase noise compensation apparatus and an OFDM system having the apparatus and method thereof

(75) Inventors: Woo-jong Park, Seoul (KR); Kiran Bynam, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/495,724

(22) Filed: Jul. 31, 2006

(30) Foreign Application Priority Data
Jul. 29, 2005 (KR) 2005-69357

(51) Int. Cl. H04K 1/10; H04B 1/10

(52) U.S. Cl. 375/260; 375/350

(57) ABSTRACT

Disclosed is a phase noise compensation apparatus to be applied to the OFDM system, comprising an ICI estimating unit for estimating inter carrier interference (ICI) using a pilot sub-carrier included in a reception signal, a estimating unit for estimating a common phase error (CPE), which is a phase noise from the reception signal as sampled, using the pilot sub-carrier, and estimating a transmission signal by removing the estimated CPE from the reception signal, a calculating unit for calculating phase change by the ICI in the reception signal by convoluting the ICI and the transmission signal, and an equalizer for compensating the calculated phase change by the ICI in the reception signal. Accordingly, phase noise can be exactly compensated by estimating as phase noise the result of convoluting a received signal where the CPE is removed in a frequency domain and the estimated ICI according to the present invention.

### CROSS-REFERENCE TO RELATED APPLICATIONS

This application claims benefit under 35 U.S.C. § 119(a) of Korean Patent Application No. 2005-69357, filed Jul. 29, 2005 in the Korean Intellectual Property Office, the entire contents of which are incorporated herein by reference.

### BACKGROUND OF THE INVENTION

1. Field of the Invention

The present invention relates to a phase noise compensation apparatus that, for example, can be used in an Orthogonal frequency division multiplexing (OFDM) system and a method thereof. More particularly, the present invention relates to a phase noise compensation apparatus which removes phase noise using a common phase error-free (CPE-free) reception signal and an inter carrier interference (ICI) estimated using a pilot signal.

2. Description of the Related Art

OFDM is a technique in which columns of serially input data are converted into parallel data blocks. Parallel data symbols are multiplexed in a orthogonal different carrier wave frequency and wideband transmission is changed into plural narrowband parallel transmission. The OFDM method is strong in multipath fading of wireless communication environment and can transmit data at high speed.

In a related art OFDM system, symbol timing is used to find the exact beginning and end of each OFDM symbol. However when the symbol timing is not optimized, inter carrier interference (ICI) can occur. Additionally, an OFDM receiver converts a reception signal of analog into a digital signal by sampling the reception signal in a certain frequency using an oscillator. When the certain frequency is not the same as an oscillated frequency of a transmitter, phase change can occur in the reception signal. Accordingly, phase change by the ICI or CPE needs to be removed to detect the exact reception signal.

However, conventional phase noise compensation methods, disclosed in US Patent Publication No. US2002/0159533 and US Patent Publication No. US2004/0190637 compensate phase noise by estimating the CPE without phase compensation by the ICI so that phase noise included in a reception signal can not be exactly compensated.

### SUMMARY OF THE INVENTION

An aspect of the present invention is to solve at least the above problems and/or disadvantages and to provide at least the advantages described below. Accordingly, an aspect of the present invention is to provide a phase noise compensation apparatus. For example, such an apparatus can be used in an the OFDM system for detecting an exact transmission signal by compensating phase noise by estimating convolutions of a CPE-removed reception signal and the ICI as the phase noise, and a method thereof.

In order to achieve the above-described aspect of the present invention, there is provided a phase noise compensation apparatus, comprising an ICI estimating unit operable to estimate inter carrier interference using a pilot sub-carrier included in a reception signal. An estimating unit operable to estimate a common phase error using the pilot sub-carrier. The common phase is a phase noise from the reception signal as sampled. The estimating unit is further operable to estimate a transmission signal by removing the estimated common phase error from the reception signal. A calculating unit is provided that is operable to calculate phase change by the inter carrier interference in the reception signal by convoluting the inter carrier interference and the transmission signal. An equalizer is provided that is operable to compensate the calculated phase change by the inter carrier interference in the reception signal.

The phase noise compensation apparatus may further comprise an analog-to-digital (AD) converter operable to sample the reception signal based on a certain sampling frequency, and a fast Fourier transform (FFT) unit operable to convert the sampled reception signal in a frequency domain.

Another aspect of the present invention is an OFDM system further including the above-discussed phase noise compensation apparatus.

Another aspect of the present invention is a phase noise compensation method that comprises estimating inter carrier interference (ICI) using a pilot sub-carrier included in a reception signal. A common phase error (CPE), which is a phase noise from the reception signal as sampled, is estimated using the pilot sub-carrier. A transmission signal is estimate by removing the estimated CPE from the reception signal. The phase change is calculated by the ICI in the reception signal by convoluting the ICI and the transmission signal. The calculated phase change is compensated by the ICI in the reception signal.

The phase noise compensation may further comprise sampling the reception signal based on a certain sampling frequency, and converting the sampled reception signal in a frequency domain.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a block diagram showing a phase noise compensation apparatus to be applied to the OFDM system according to an exemplary embodiment of the present invention;

FIG. 2 is a block diagram showing a phase noise estimating unit according to an exemplary embodiment of the present invention;

FIG. 3 is a flow chart showing a phase noise compensation method according to an exemplary embodiment of the present invention; and

FIG. 4 is a graph comparing the result of simulating performance of a phase noise compensation method of the present invention and a conventional phase noise compensation method.

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

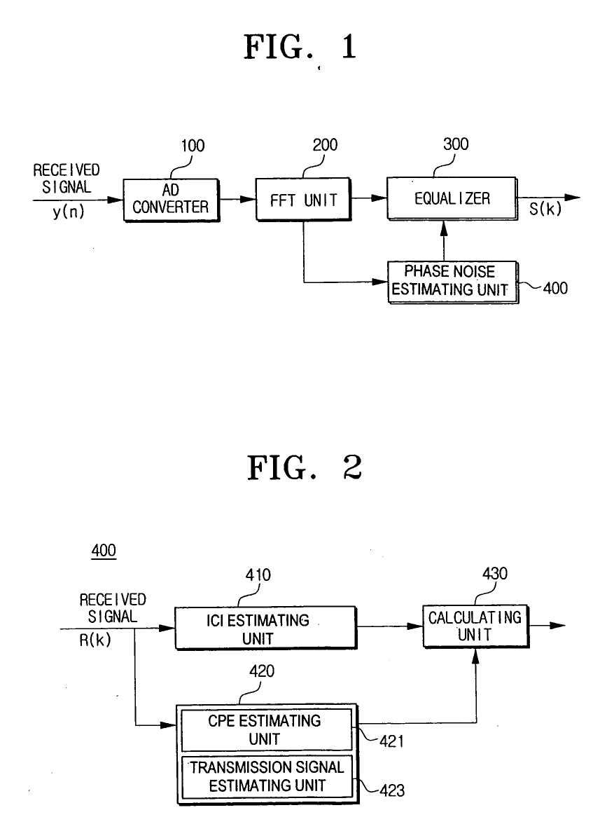

FIG. 1 is a block diagram showing a phase noise compensation according to an exemplary embodiment of the present invention. Such an apparatus could be used in an OFDM system. FIG. 2 is a block diagram showing a phase noise estimating unit 400 according to an exemplary embodiment of the present invention.

Referring to FIG. 1, the phase noise compensation apparatus according to the present invention is applied, includes an AD converter 100, a fast Fourier transform (FFT) unit 200, an equalizer 300 and a phase noise estimating unit 400. As noted, such an apparatus could be used in an OFDM system.

The AD converter 100 samples a received signal according to a sampling frequency generated in an oscillator (not shown) to convert the received analog signal into a digital signal.

The FFT unit 200 transforms the sampled reception signal in a frequency domain.

The phase noise estimating unit 400 includes an ICI estimating unit 410, a CPE/TS (a common phase error/transmission signal) estimating unit 420 and a calculating unit 430. The phase noise estimating unit 400 estimates a common phase error (CPE) from the reception signal in frequency domain and also estimates phase noise by the ICI.

Specifically, the ICI estimating unit 410 estimates the ICI using a pilot sub-carrier known by the transmission and reception ends.

The CPE/TS estimating unit 420 includes a CPE estimating unit 421 and a transmission signal (TS) estimating unit 423. The CPE/TS estimating unit 420 estimates phase noise by the CPE using a pilot signal, removes the chase noise by the CPE from the reception signal and estimates the phase-noise-removed signal as a transmission signal. The CPE estimating unit 421 estimates the CPE using the pilot sub-carrier. The transmission signal estimating unit 423 removes the phase noise by the CPE estimated from the reception signal transformed in a frequency domain and estimates the phase-noise-removed signal as the transmission signal.

The calculating unit 430 calculates phase noise of the reception signal using the output of the ICI estimating unit 410 and the output of the CPE/TS estimating unit 420. The calculating unit 430 calculates phase noise included in the reception signal by convoluting the estimated ICI and the CPE-removed reception signal.

The equalizer 300 receives the phase change of the reception signal occurred by phase noise from the phase noise estimating unit 400 and removes the phase change from the reception signal to compensate phase change by the ICI and phase change by the CPE.

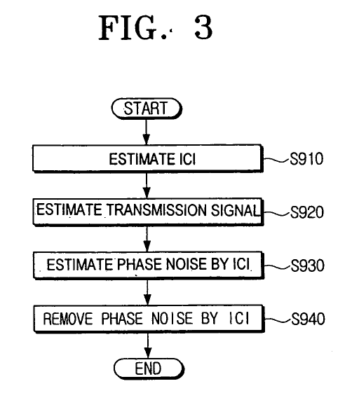

FIG. 3 is a flow chart showing a phase noise compensation method according to an embodiment of the present invention.

Referring to FIG. 3, firstly, the ICI is estimated using a pilot signal (S910). If a reception signal is received, the reception signal is periodically sampled using the AD converter 100 and the sampled reception signal is converted in a frequency domain. The reception signal is represented as follows.
y(n)=x(n)*e^{j*Φ(n)}+w(n) [Equation 1]

Here, y(n) denotes the reception signal and x(n) denotes the transmission signal. w(n) denotes white Gaussian noise and Φ(n) denotes phase noise.

The reception signal which is sampled and converted in the frequency domain is expressed as [Equation 2] and [Equation 3].

$$\begin{matrix}R ( k ) = {\sum }_{n = 1}^{N - 1} y ( n ) * {ⅇ}^{- j2π kn / N} & [ Equation 2 ] \\ R ( k ) = {\sum }_{n = 1}^{N - 1} ( x ( n ) * {ⅇ}^{j * Φ ( n )} + w ( n ) ) * {ⅇ}^{- j2π ka / N} & [ Equation 3 ]\end{matrix}$$

In Equation 2 and Equation 3 where Equation 1 is substituted for y(n) of Equation 2, R(k) is a value that the reception signal y(n) is DFT(Discrete Fourier Transform)-performed, that is, a value that the reception signal is represented in the frequency domain, and y(n) is the reception signal. N denotes a FFT window size.

In Equation 3, since a variation on Φ(n) is considerably less than 1, e^{jΦ(n)} can be denoted as 1+jΦ(n). Accordingly, Equation 3 is equal to Equation 4.

$$R ( k ) = {\sum }_{n = 1}^{N - 1} ( x ( n ) * ( 1 + j * Φ ( n ) ) + w ( n ) ) * {ⅇ}^{- j2π kn / N} \\ R ( k ) = {\sum }_{n = 1}^{N - 1} x ( n ) * {ⅇ}^{- j2π kn / N} + {\sum }_{n = 1}^{N - 1} j * Φ ( n ) * {ⅇ}^{- j2π kn / N} \qquad [ Equation 4 ]$$

Herein,

$${\sum }_{n = 1}^{N - 1} x ( n ) * {ⅇ}^{- j2π kn / N}$$

is equal to the result that the transmission signal x(n) is Fourier-transformed and can be substituted as S(k). Therefore, Equation 4 can be reformulated as follows.

$$R ( k ) = S ( k ) + j \frac{1}{N} {\sum }_{n = 1}^{N - 1} {\sum }_{r = 1}^{N - 1} S ( r ) {ⅇ}^{j2π rn / N} * Φ ( n ) {ⅇ}^{- j2π kn / N} \\ R ( k ) = S ( k ) + j \frac{1}{N} {\sum }_{r = 1}^{N - 1} S ( r ) {\sum }_{n = 1}^{N - 1} {ⅇ}^{j2π rn / N} * Φ ( n ) {ⅇ}^{- j2π kn / N} \qquad [ Equation 5 ]$$

Herein, S(k) denotes the transmission signal in the frequency domain, r denotes index of the pilot sub-carrier, Φ(n) denotes phase noise sample and N denotes the number of the sub-carrier.

Additionally, in Equation 5,

$${\sum }_{n = 1}^{N - 1} {ⅇ}^{j2π rn / N} * Φ ( n ) {ⅇ}^{- j2π kn / N}$$

is a Discrete Fourier Transform (DFT) of Φ(n) so that Ω can be substituted for Φ(n). Accordingly, Equation 5 can be reformulated as follows.

$$R ( k ) = S ( k ) + j \frac{1}{N} {\sum }_{n = 1}^{N - 1} {\sum }_{r = 1}^{N - 1} S ( r ) * Ω ( k - r ) \qquad [ Equation 6 ]$$

Herein, Ω(k) is a DFT value of Φ(n), that is, a value denoting phase noise in the frequency domain. In Equation 6, phase change of the reception signal by phase noise is represented as follows.

$$j \frac{1}{N} {\sum }_{n = 1}^{N - 1} {\sum }_{r = 1}^{N - 1} S ( r ) * Ω ( k - r ) \qquad [ Equation 7 ]$$

Equation 7 denotes phase change of the reception signal by phase noise of ICI in the reception signal. Especially, Ω(0) denotes phase change by a sub-carrier with the lowest index of symbols of the reception signal. A sampling frequency error has a linear relation with phase rotation occurred by index of the pilot sub-carrier so that the pilot sub-carrier with the lowest index which is placed outside in one symbol has the largest phase change. Accordingly, Ω(0) can be estimated as CPE and a term of more than Ω(1) can be estimated as phase noise by the ICI.

Therefore, ICI presumption performed in S910 estimates phase noise by the ICI by calculating a term of more than Ω(1) in Equation 7.

The transmission signal is estimated based on the CPE estimated using the pilot signal (S920). Phase noise by the ICI can be estimated using Equation 7 by estimating S(r) which is the transmission signal without phase noise transmitted from the transmitter.

The transmission signal S(r) can be estimated by calculating the CPE occurred by an error of oscillation frequency used upon sampling the reception signal and removing the CPE from the reception signal. The CPE can be estimated by calculating Ω(0) as described above.

Using the ICI estimated in S910 and the transmission signal estimated in S920, phase change of the reception signal by the ICI is estimated (S930). Using Equation 7, phase noise by the ICI can be estimated by the calculated term of more than Ω(1) in S910 and convoluting the transmission signal S(r) in S920.

Subsequently, the phase noise is compensated by removing the estimated phase noise by the ICI from the reception signal (S940) so that the exact transmission signal is detected. By removing Equation 7 which is phase noise estimated in S940 from Equation 6, the exact transmission signal where phase noise is compensated can be received.

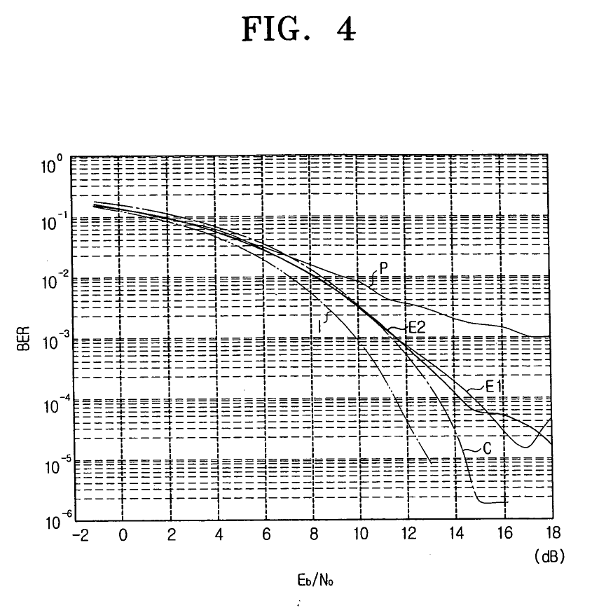

FIG. 4 is a graph showing the result of simulating performance of a phase noise compensation method of the present invention and a conventional phase noise compensation method. When both phase noise compensation methods respectively are applied, FIG. 4 shows the bit error rate (BER) according to E_{b}/N₀.

Herein, C is the case which the phase noise compensation method according to the present invention is applied to, I is the case in which phase noise is ideally compensated, and P, E1 and E2 are the cases which conventional phase noise compensation methods are applied to. P represents the case that the reception signal has phase noise, E1 represents the case that phase noise by the CPE and phase noise by the ICI are compensated, and E2 represents the case that only phase noise by the CPE is compensated.

As shown in FIG. 4, compensating phase noise according to the present invention is lower in the BER than compensating phase noise according to the conventional methods (E1, E2). According to the present invention, phase noise is exactly compensated so that a transmission signal with less errors can be received.

As can be appreciated from the above description, phase noise can be exactly compensated by estimating as phase noise the result of convoluting a received signal where the CPE is removed in a frequency domain and the estimated ICI according to the present invention. Accordingly, the exact transmission signal can be detected by exactly compensating phase noise from the reception signal.

While the invention has been shown and described with reference to certain embodiments thereof, it will be understood by those skilled in the art that various changes in form and details may be made therein without departing from the spirit and scope of the invention as defined by the appended claims.

What is claimed is:

1. A phase noise compensation apparatus, comprising:
an intercarrier estimating unit operable to estimate inter carrier interference using a pilot sub-carrier included in a reception signal;
a estimating unit operable to estimate a common phase error, the common phase error being a phase noise from the reception signal as sampled, using the pilot sub-carrier, the estimating unit further operable to estimate a transmission signal by removing the estimated common phase error from the reception signal;
a calculating unit operable to calculate phase change by the inter carrier interference in the reception signal by convoluting the inter carrier interference and the transmission signal; and
an equalizer operable to compensate the calculated phase change by the inter carrier interference in the reception signal.

2. The phase noise compensation apparatus of claim 1, further comprising:
an analog-to-digital converter operable to sample the reception signal based on a certain sampling frequency; and
a fast Fourier transform unit operable to convert the sampled reception signal in a frequency domain.

3. An orthogonal frequency division multiplexing system comprising a phase noise compensation apparatus, the phase noise compensation apparatus further comprising:
an intercarrier estimating unit operable to estimate inter carrier interference using a pilot sub-carrier included in a reception signal;
a estimating unit operable to estimate a common phase error, the common phase error being a phase noise from the reception signal as sampled, using the pilot sub-carrier, the estimating unit further operable to estimate a transmission signal by removing the estimated common phase error from the reception signal;
a calculating unit operable to calculate phase change by the inter carrier interference in the reception signal by convoluting the inter carrier interference and the transmission signal; and
an equalizer operable to compensate the calculated phase change by the inter carrier interference in the reception signal.

4. An orthogonal frequency division multiplexing system comprising a phase noise compensation apparatus, the phase noise compensation apparatus further comprises:
an analog-to-digital converter operable to sample the reception signal based on a certain sampling frequency; and
a fast Fourier transform unit operable to convert the sampled reception signal in a frequency domain.

5. A phase noise compensation method, comprising:
estimating inter carrier interference using a pilot sub-carrier included in a reception signal;
estimating a common phase error, the common phase error being a phase noise from the reception signal as sampled, using the pilot sub-carrier;
estimating a transmission signal by removing the estimated common phase error from the reception signal;
calculating phase change by the inter carrier interference in the reception signal by convoluting the inter carrier interference and the transmission signal; and
compensating the calculated phase change by the inter carrier interference in the reception signal.

6. The phase noise compensation method of claim 5, further comprising:
sampling the reception signal based on a certain sampling frequency; and
converting the sampled reception signal in a frequency domain.
